(19) United States
(12) Patent Application Publication
(10) Pub. No.: US 2026/0126585 A1
(43) Pub. Date: May 7, 2026

(54) SPOT SIZE CONVERTER INCLUDING A TWO-DIMENSIONAL BI-ANISOTROPIC SUBWAVELENGTH GRATING STRUCTURE

(71) Applicant: Lumentum Operations LLC, San Jose, CA (US)

(72) Inventors: Md Borhan MIA, San Jose, CA (US); Kenneth A. MCGREER, San Jose, CA (US)

(21) Appl. No.: 19/000,462

(22) Filed: Dec. 23, 2024

Related U.S. Application Data
(60) Provisional application No. 63/717,650, filed on Nov. 7, 2024.

(51) Int. Cl. G02B 6/122; G02B 6/124

(52) U.S. Cl. CPC G02B 6/1228; G02B 6/124

(57) ABSTRACT

In some implementations, a photonic integrated circuit (PIC) may include a spot size converter (SSC). The SSC may include a tapered waveguide having a length along a first direction and a width along a second direction. The first direction may be parallel to a direction of propagation and the second direction may be perpendicular to the direction of propagation. The SSC may include a two-dimensional (2D) bi-anisotropic subwavelength grating (SWG) structure. A portion of the 2D bi-anisotropic SWG structure may surround a portion of the tapered waveguide in the second direction and along the first direction.

### CROSS-REFERENCE TO RELATED APPLICATION

This patent application claims priority to U.S. Provisional Application No. 63/717,650, filed on Nov. 7, 2024, and entitled “MODE SIZE CONVERTER INCLUDING SUBWAVELENGTH GRATING METAMATERIALS.” The disclosure of the prior application is considered part of and is incorporated by reference into this patent application.

### TECHNICAL FIELD

The present disclosure relates generally to a spot size converter (SSC) and to an SSC including a two-dimensional (2D) bi-anisotropic subwavelength grating (SWG) structure.

### BACKGROUND

An SSC is an optical device that can be used to enable fiber-to-chip coupling by matching a mode field diameter (also referred to as a spot size) of an optical fiber to a mode size of a photonic waveguide on an integrated chip. The mode field diameter of a standard single-mode optical fiber (e.g., in a range from approximately 8 micrometers (μm) to approximately 10 μm at a 1550 nanometer (nm) wavelength) is significantly larger than the mode size in a waveguide on a photonic chip (e.g., in a range from approximately 0.5 μm to approximately 2 μm).

Without an SSC, there would be a significant mismatch between the field distributions of the fiber and waveguide modes, leading to poor coupling efficiency and higher insertion loss. An SSC serves to reduce this mismatch, which improves power transfer between the fiber and the waveguide. The improved mode matching provided by the SSC can also reduce back reflection, which would otherwise degrade performance of an optical system.

### SUMMARY

In some implementations, a photonic integrated circuit (PIC) comprising an SSC includes a tapered waveguide having a length along a first direction and a width along a second direction, wherein the first direction is parallel to a direction of propagation and the second direction is perpendicular to the direction of propagation; and a 2D bi-anisotropic SWG structure, wherein a portion of the 2D bi-anisotropic SWG structure surrounds a portion of the tapered waveguide in the second direction and along the first direction.

In some implementations, a PIC comprising an SSC includes a first section comprising a first portion of a tapered waveguide; a second section comprising a second portion of the tapered waveguide and a first portion of a bi-anisotropic SWG structure comprising a plurality of grating elements, wherein the second portion of the bi-anisotropic SWG structure surrounds the second portion of the tapered waveguide along a length of the second section; and a third section comprising a second portion of the bi-anisotropic SWG structure.

In some implementations, a PIC comprising an SSC includes a waveguide having a length along a first direction and a width along a second direction that is perpendicular to the first direction; and a 2D bi-anisotropic SWG structure around a portion of the tapered waveguide along the first direction, wherein a dielectric constant of the bi-anisotropic SWG structure with respect to the first direction is different from a dielectric constant of the bi-anisotropic SWG structure with respect to the second direction, and wherein the dielectric constant of the bi-anisotropic SWG structure with respect to a third direction is different from the dielectric constant of the bi-anisotropic SWG structure with respect to the first direction and the dielectric constant of the bi-anisotropic SWG structure with respect to the second direction.

### BRIEF DESCRIPTION OF THE DRAWINGS

FIGS. 1A-1B are diagrams illustrating example implementations of an SSC including a 2D bi-anisotropic SWG structure described herein.

FIG. 2 is a diagram illustrating grating elements of a 2D bi-anisotropic SWG structure described herein distributed along a direction of propagation based on a Gaussian distribution.

FIGS. 3-6 are diagrams illustrating simulation results associated with various example implementations of an SSC including a 2D bi-anisotropic SWG structure described herein.

FIGS. 7-12 are diagrams illustrating simulation results illustrating effects of different parametric variations associated with an SSC including a 2D bi-anisotropic SWG structure described herein.

FIGS. 13-14 are diagrams illustrating simulation results illustrating insertion loss and PDL associated with an SSC including a 2D bi-anisotropic SWG structure described herein.

### DETAILED DESCRIPTION

The following detailed description of example implementations refers to the accompanying drawings. The same reference numbers in different drawings may identify the same or similar elements. Please note that references herein to letter-designated optical bands (e.g. O-band, C-band, L-band, or the like) refer to the International Telecommunication Unit (ITU) optical bands in the near infrared.

Fiber-to-chip coupling is a challenge with respect to the development of silicon photonics-based devices, which are integral to increasing efficiency of optical communication systems. Two conventional techniques for interfacing a standard single-mode optical fiber (e.g., SMF-28) with a silicon photonic (SiPho) waveguide are edge coupling and grating coupling. Each of these fiber-to-chip coupling techniques presents advantages and trade-offs regarding efficiency, bandwidth, and fabrication complexity.

Edge coupling provides broad bandwidth and low polarization dependency and, therefore, is conventionally used for a variety of applications. However, edge coupling is not a suitable solution in a high-power application due to two-photon absorption in silicon, which leads to increased insertion losses. Improvement of a design of edge coupling SSCs using silicon (Si) and silicon nitride (SiNₓ) have been proposed to address these challenges. SiNₓ may in some cases be a superior material choice because SiNₓ offers lower optical losses, reduced surface roughness, and reduced nonlinearity as compared to Si. These improvements can in some applications improve reliability and effectiveness of edge coupling SSCs. A trident-shaped partially etched Si SSC can reduce coupling losses (e.g., to below 1.25 decibels (dB)) with low polarization-dependent loss (PDL). Such a design uses a trident-shaped configuration and can enhance mode overlap and reduce sensitivity to etch depth variations, which can provide a robust solution for coupling in the O-band (e.g., 1260 nm to 1360 nm). However, the high nonlinearity of Si results in loss when exposed to high power, which makes such a design unsuitable for high-power applications.

In some cases, subwavelength grating (SWG) structures (also referred to as metamaterials) can be used to enhance performance of an SSC. An SWG structure may achieve lower loss, higher bandwidth, and reduced nonlinearity, which are crucial for some applications, such as high-power applications. One example uses anisotropic SiNₓ metamaterials, which may provide improvements in bandwidth. However, such SWG structures face challenges with respect to insertion loss, which can exceed, for example, 2 dB for both the transverse electric (TE) polarization and the transverse magnetic (TM) polarization. In another example, an Si anisotropic metamaterials SSC with a worst-case loss of 1.2 dB has been proposed. In such an SSC, the SWG structure includes a 1-dimensional (1D) array of grating elements. However, further improvements using SWG designs are desirable. What is needed is an SSC design that accommodates increasingly stringent requirements of photonic systems, which demand efficient, low-loss coupling that can operate over broad spectral ranges and at high power levels without significant performance degradation.

Some implementations described herein provide an SSC comprising a 2D bi-anisotropic SWG structure. In some implementations, an SSC (e.g., on a photonic integrated circuit (PIC)) may include a tapered waveguide and a 2D bi-anisotropic SWG structure. The tapered waveguide may have a length along a first direction and a width along a second direction, with the first direction being parallel to a direction of propagation and the second direction being perpendicular to the direction of propagation. A portion of the 2D bi-anisotropic SWG structure may surround a portion of the tapered waveguide in the second direction and along the first direction.

In some implementations, the SSC including the 2D bi-anisotropic SWG structure may be fabricated on a Si material platform or on a SiNₓ material platform. Notably, while 1D anisotropic SWG/metamaterials have been used in some conventional SSCs, as described above, such designs struggle with insertion loss, high nonlinearity, and tolerance due to variations in waveguide parameters in fabrication. Further, while a conventional anisotropic Si 1D SWG-based SSC may provide lower nonlinearity, the SSC including the 2D bi-anisotropic SWG structure described herein further enhances tolerance and reduces nonlinearity, even at high power levels. Similarly, while a conventional SiNₓ SWG-based SSC inherently possesses a low nonlinear coefficient, an SSC including a 2D bi-anisotropic SiNₓ SWG structure described herein further decreases nonlinearity and improves fabrication tolerance.

In some implementations, the SSC including the 2D bi-anisotropic SWG structure described herein may (1) reduce high nonlinear loss at high optical power (e.g., within an Si platform), (2) improve tolerance to parameter variations (e.g., both Si and SiNₓ platforms), (3) support a hybrid design combining Si and SiNₓ, which provides flexibility for various applications, and/or (4) be applicable across multiple bands (e.g., the O-band, the C+L bands, or the like), thereby enhancing utility in broader photonic systems.

Further, according to conventional techniques described above, an SSC may in some cases include an SWG structure consisting of a 1D array of grating elements. In such a design, engineering of a refractive index can occur with respect to only one dimension—along a direction of propagation (e.g., a z-direction). However, in order to control a mode field, two directions (e.g., an x-direction and a z-direction) need to be controlled to match a mode field diameter with a single mode fiber. With such mode field control, the conventional 1D array design can suffer from high loss, high nonlinearity, and low tolerance, which are not suitable for high power applications. In some implementations, the SSC including the 2D bi-anisotropic SWG structure described herein can be used to provide an SSC and address such issues, while enhancing performance. That is, in some implementations, control of the refractive index in two directions (e.g., the x-direction and the z-direction) is enabled by the 2D bi-anisotropic SWG structure. In some implementations, grating elements of the 2D bi-anisotropic SWG structure may be distributed according to a pattern (e.g., based on a Gaussian pattern, a linear pattern, an apodized pattern, or a parabolic pattern) so as to smooth a mode transition (e.g., from waveguide to fiber mode or from fiber mode to waveguide) while reducing insertion loss, absorption loss (e.g., at high power), and reflection. Further, an SSC comprising a 2D bi-anisotropic SWG structure may be less dependent on tip width variations, thereby increasing fabrication tolerance. Additional details are provided below.

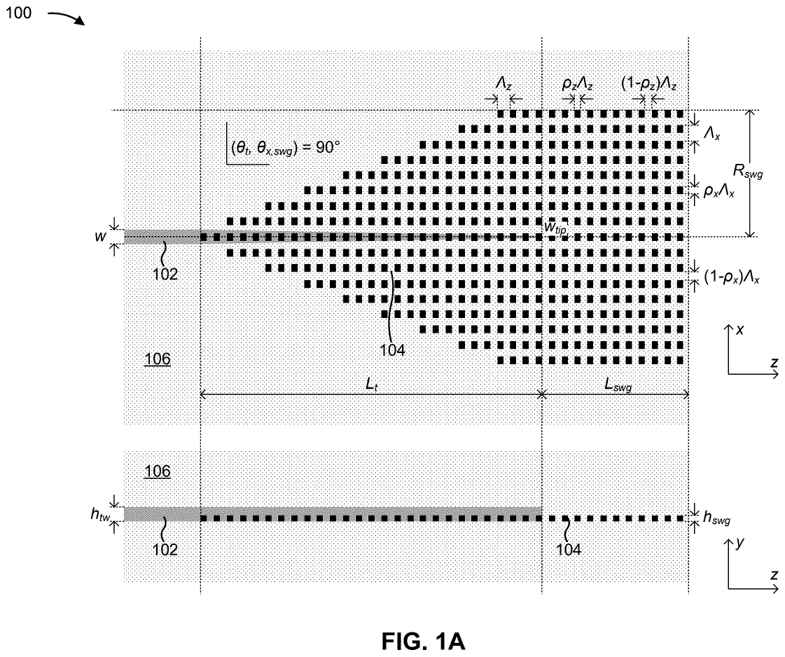

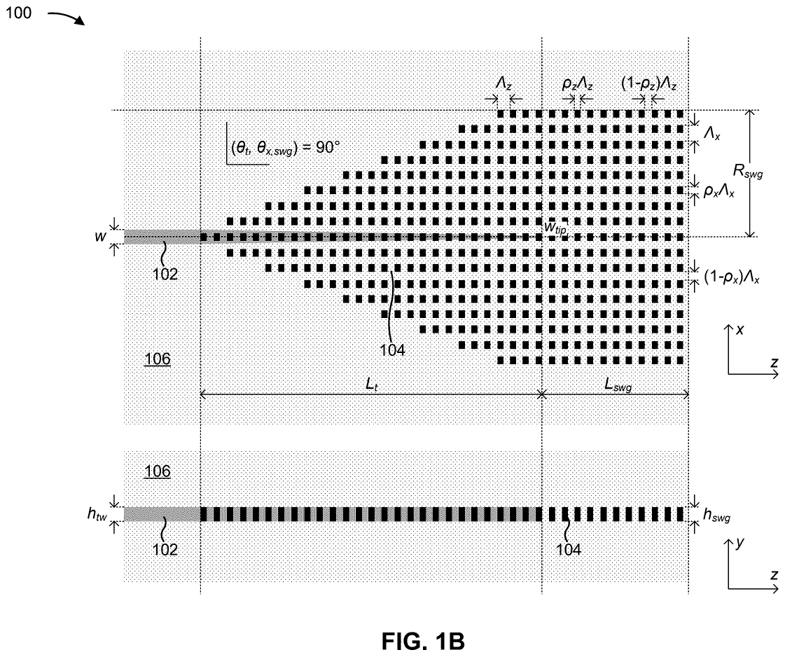

FIGS. 1A-1B are diagrams illustrating example implementations of an SSC 100 including a 2D bi-anisotropic SWG structure described herein. The upper diagrams in FIGS. 1A and 1B illustrate plan views of the SSC 100 (e.g., on an x-z plane), while the lower diagrams in FIGS. 1A and 1B illustrate cross-sectional views along a center line of the SSC 100 (e.g., on a y-z plane). In some implementations, the SSC 100 may be implemented in a PIC. As shown in FIGS. 1A and 1B, the SSC 100 may comprise a tapered waveguide 102, a 2D bi-anisotropic SWG structure 104 comprising a plurality of grating elements (indicated as black squares), and a cladding 106.

In some implementations, one or more elements of the SSC 100 may be formed utilizing a Si platform. Thus, in some implementations, the tapered waveguide 102 and/or one or more grating elements of the 2D bi-anisotropic SWG structure 104 may comprise Si. Additionally, or alternatively, one or more elements of the SSC 100 may be formed utilizing a SiNₓ platform. Thus, in some implementations, the tapered waveguide 102 and/or one or more grating elements of the 2D bi-anisotropic SWG structure 104 may comprise SiNₓ. In one example implementation, the 2D bi-anisotropic SWG structure 104 includes SiNₓ grating elements surrounded by cladding 106. In another example implementation, the 2D bi-anisotropic SWG structure 104 includes Si grating elements surround by cladding 106. In some implementations, the SSC 100 may use a hybrid design in which one or more elements (e.g., the tapered waveguide 102) of the SSC 100 comprise Si and one or more other elements (e.g., grating elements of the 2D bi-anisotropic SWG structure 104) of the SSC 100 comprise SiNₓ.

In some implementations, the cladding 106 may comprise one or more of silica, an index matching fluid, or air. For example, a bottom portion of the cladding 106 (e.g., a portion of the cladding 106 below the tapered waveguide 102 and the grating elements of the 2D bi-anisotropic SWG structure 104) may comprise silica, and a top portion of the cladding 106 (e.g., a portion of the cladding 106 above the grating elements of the 2D bi-anisotropic SWG structure 104 and between the grating elements of the 2D bi-anisotropic SWG structure 104) may comprise an index matching fluid and/or air. In some implementations, the index matching fluid may be an adhesive designed to have a refractive index that is close to a refractive index of a material of another portion of the cladding 106 at a selected wavelength (e.g., to reduce reflection and scattering at an interface between the silica and the index matching fluid). In one example, the bottom portion of the cladding 106 may comprise silica, and the top portion of the cladding 106 may comprise an index matching fluid in the form of an epoxy that has a refractive index that is close to that of silica.

In some implementations, as illustrated in FIGS. 1A-1B, the tapered waveguide 102 has a length along a first direction (herein referred to as a z-direction) and a width along a second direction (herein referred to as an x-direction). Here, the z-direction is parallel to a direction of propagation of light through the SSC 100 and the x-direction is perpendicular to the direction of propagation. In some implementations, as shown, a width of the tapered waveguide 102 changes along the z-direction over a taper length Lₜ such that the width of the tapered waveguide 102 is a width w at an input/output facet of the SSC 100 and is a width wₜᵢₚ (w>wₜᵢₚ) at a tip of the tapered waveguide 102. In some implementations, the tapered waveguide 102 has a height h_{tw}. In some implementations, the tapered waveguide 102 may be a segmented waveguide. That is, in some implementations, the tapered waveguide 102 may comprise multiple waveguide segments, with a portion of the cladding 106 being between a given pair of adjacent waveguide segments of the tapered waveguide 102. In such an implementation, the tapered waveguide 102 may be segmented with respect to the x-direction such that the tapered waveguide 102 has a periodicity in the x-direction and/or may be segmented with respect to the z-direction such that the tapered waveguide 102 has a periodicity in the z-direction.

The 2D bi-anisotropic SWG structure 104 comprises a plurality of grating elements. In some implementations, one or more of the grating elements of the 2D bi-anisotropic SWG structure 104 may have a rectangular shape (e.g., a square shape), as illustrated in FIGS. 1A and 1B. Additionally, or alternatively, one or more of the grating elements of the 2D bi-anisotropic SWG structure 104 may have another type of shape, such as an elliptical shape, a trapezoidal shape, a rounded shape, a circular shape, or the like. As shown, in some implementations, the grating elements of the 2D bi-anisotropic SWG structure 104 may be distributed based on a Gaussian distribution with respect to the x-z plane. Alternatively, the grating elements may be distributed or arranged in another manner, such as based on a linear pattern, an apodized pattern, or a parabolic pattern. In some implementations, the distribution of the grating elements may be selected so as to smooth a mode transition (e.g., from waveguide to fiber mode or from fiber mode to waveguide) while reducing insertion loss, absorption loss (e.g., at high power) and reflection. In some implementations, the grating elements of the 2D bi-anisotropic SWG structure 104 may be symmetrically distributed along the tapered waveguide 102 and may extend along the x-direction.

In some implementations, as illustrated in FIGS. 1A and 1B, one or more of the grating elements of the 2D bi-anisotropic SWG structure 104 may be oriented at 90 degrees (°) with respect to the direction of propagation. Additionally, or alternatively, one or more of the grating elements of the 2D bi-anisotropic SWG structure 104 may be oriented at an arbitrary angle (e.g., an angle that is less than 90°) with respect to the direction of propagation. For example, one or more of the grating elements of the 2D bi-anisotropic SWG structure 104 may be oriented at an angle between 50° and 900 or at an angle between 70° and 90°. In some implementations, the one or more grating elements may be oriented at an arbitrary angle to control one or more performance characteristics of the 2D bi-anisotropic SWG structure 104, such as back-reflection of the 2D bi-anisotropic SWG structure 104. In some implementations, an overall width of the 2D bi-anisotropic SWG structure 104 may change along the z-direction over the taper length Lₜ (e.g., based on the distribution of the grating elements) such that the overall width of the 2D bi-anisotropic SWG structure 104 is equal to two times a radius R_{swg} of the 2D bi-anisotropic SWG structure 104 (i.e., 2×R_{swg}) at an output/input facet of the SSC 100.

In some implementations, as illustrated in FIG. 1A, the height h_{swg} of one or more of the grating elements of the 2D bi-anisotropic SWG structure 104 may be different than (e.g., less than) the height h_{tw} of the tapered waveguide 102. Additionally, or alternatively, as illustrated in FIG. 1B, the height h_{swg} of one or more of the grating elements of the 2D bi-anisotropic SWG structure 104 may match (e.g., be approximately equal to) the height h_{tw} of the tapered waveguide 102.

As shown, a portion of the 2D bi-anisotropic SWG structure 104 (e.g., some grating elements of the 2D bi-anisotropic SWG structure 104) may surround a portion of the tapered waveguide 102 along the length Lₜ in the x-direction and along the z-direction. As further shown, in some implementations, only grating elements of the 2D bi-anisotropic SWG structure 104 and portions of the cladding 106 are present along a length L_{swg} of the SSC 100 (i.e., the tapered waveguide 102 is not present along a length L_{swg} of the SSC 100).

As shown in FIGS. 1A and 1B, the grating elements of the 2D bi-anisotropic SWG structure 104 have a periodicity Λₓ and a filling fraction ρₓ with respect to the x-direction. A width of a given grating element in the x-direction is a value equal to Λₓρₓ, and a width of a gap between a pair of adjacent grating elements in the x-direction (e.g., a width of a portion of cladding 106 between the pair of adjacent grating elements in the x-direction) is a value equal to (1−ρₓ)Λₓ. Similarly, the grating elements of the 2D bi-anisotropic SWG structure 104 have a periodicity Λ_{z} and a filling fraction ρ_{z} with respect to the z-direction. A length of a given grating element in the z-direction is a value equal to A ρ_{z}, and a length of a gap between a pair of adjacent grating elements in the z-direction (e.g., a length of a portion of cladding 106 between the pair of adjacent grating elements in the z-direction) is a value equal to (1−ρ_{z})Λ_{z}.

In some implementations, the periodicity Λₓ and the periodicity Λ_{z} may be smaller than an operational wavelength λ of the SSC 100 (e.g., for the C-band, λ may be approximately 1550 nm). In some implementations, by setting the periodicities Λₓ and Λ_{z} to be smaller than λ, diffraction effects are reduced or minimized. In one example, the periodicity Λₓ and/or the periodicity Λ_{z} may be less than approximately λ/n, where λ is an operational wavelength associated with the SSC 100 and n is a refractive index of the 2D bi-anisotropic SWG structure 104. Thus, in some implementations, a dimension (e.g., a width and/or a length) of a given grating element of the 2D bi-anisotropic SWG structure 104 may be based on a wavelength range associated with the SSC 100 (e.g., so as to provide a 2D bi-anisotropic SWG structure 104 with an appropriately small refractive index n with respect to the operational wavelength of the SSC 100).

In some implementations, the periodicity Λₓ of grating elements of the 2D bi-anisotropic SWG structure 104 is different from a periodicity Λ_{z} of the grating elements of the 2D bi-anisotropic SWG structure 104. In such an implementation, this difference in periodicity may cause a dielectric constant of the 2D bi-anisotropic SWG structure 104 with respect to the x-direction (εₓ) to be different from a dielectric constant of the 2D bi-anisotropic SWG structure 104 with respect to the z-direction (ε_{z}) and, furthermore, causes the dielectric constant εₓ and the dielectric constant ε_{z} to be different from a dielectric constant of the 2D bi-anisotropic SWG structure 104 with respect to the y-direction (Ey) (e.g., εₓ≠ε_{y}≠ε_{z}). These three different dielectric constants define the 2D bi-anisotropic SWG structure 104 as comprising a bi-anisotropic metamaterial. Alternatively, the periodicity Λₓ may in some implementations match (e.g., be approximately equal to) the periodicity Λ_{z}. Further, in some implementations, the filling fraction ρₓ may be different from the filling fraction ρ_{z}. Alternatively, the filling fraction ρₓ may in some implementations match (e.g., be approximately equal to) the filling fraction ρ_{z}. The bi-anisotropic nature of the metamaterial of the 2D bi-anisotropic SWG structure 104 metamaterial can be provided by selection of one or more the periodicity Λₓ, the periodicity Λ_{z}, the filling fraction ρₓ, and/or the filling fraction ρ_{z}.

In some implementations, the periodicity Λₓ (and the filling fraction ρₓ) may change along the x-direction (e.g., the periodicity Λₓ and the filling fraction ρₓ can gradually increase or decrease along the x-direction). Additionally, or alternatively, the periodicity Λ_{z} (and the filling fraction ρ_{z}) may change along the z-direction (e.g., the periodicity Λ_{z} and the filling fraction ρ_{z} can gradually increase or decrease along the z-direction). In some implementations, the periodicities Λₓ and Λ_{z} (and filling fractions ρₓ and ρ_{z}) may be designed so as to control light propagation along the z-axis.

In some implementations, a 2D bi-anisotropic SWG structure 104 as illustrated in FIGS. 1A-1B may be modeled using the effective medium theory (EMT) as follows:

$${ε}_{\vert \vert}^{=} {ε}_{\vert \vert}^{( 0 )} [ 1 + \frac{{π}^{2}}{3} {{ρ}^{2} ( 1 - ρ )}^{2} \frac{{( {ε}_{1} - {ε}_{2} )}^{2}}{{ε}_{\vert \vert}^{( 0 )}} {( \frac{∧}{λ} )}^{2} ] \qquad ( 1 a )$$

$${ε}_{⊥}^{=} {ε}_{⊥}^{( 0 )} [ 1 + \frac{{π}^{2}}{3} {{ρ}^{2} ( 1 - ρ )}^{2} {( \frac{{ε}_{1} - {ε}_{2}}{{ε}_{1} {ε}_{2}} )}^{2} {( {ε}_{⊥}^{( 0 )} )}^{2} {{ε}_{\vert \vert}^{( 0 )} ( \frac{∧}{λ} )}^{2} ] \qquad ( 1 b )$$

$$where :$$

$${ε}_{\vert \vert}^{( 0 )} = {ρε}_{1} + ( 1 - ρ ) {ε}_{2} , and \frac{1}{{ε}_{⊥}^{( 0 )}} = \frac{ρ}{{ε}_{1}} + \frac{1 - ρ}{{ε}_{2}}$$

Here, ρ represents the filling fraction of a core material and is specified as either ρₓ or ρ_{z}, depending on the orientation. Further, Λ represents the periodicity along a direction, which may be either Λₓ or Λ_{z}. Additionally, ε₁ denotes a core dielectric constant (e.g., ε_{Si} for an Si-based SSC 100 or ε_{SiN} for a SiNₓ-based SSC 100). Further, ε₂ represents a dielectric constant of the cladding 106 (e.g., ε_{SiO2} for silicon dioxide). In some implementations, such a modeling approach homogenizes the 2D bi-anisotropic SWG structure 104, which simplifies geometry and analysis.

As indicated above, FIGS. 1A-1B are provided as examples. Other examples may differ from what is described with regard to FIGS. 1A-1B. The number and arrangement of elements shown in FIGS. 1A-1B are provided as an example. In practice, there may be additional elements, fewer elements, different elements, or differently arranged elements than those shown in FIGS. 1A-1B. Furthermore, two or more elements shown in FIGS. 1A-1B may be implemented within a single element, or a single element shown in FIGS. 1A-1B may be implemented as multiple, distributed elements. Additionally, or alternatively, a set of elements (e.g., one or more elements) shown in FIGS. 1A-1B may perform one or more functions described as being performed by another set of elements shown in FIGS. 1A-1B.

In some implementations, as noted above, the grating elements of the 2D bi-anisotropic SWG structure 104 may be distributed along the direction of propagation (e.g., the z-direction) based on a Gaussian distribution. The Gaussian distribution can be defined by the function:

$$f ( x : μ , σ ) = \frac{1}{\sqrt{2 {πσ}^{2}}} {e}^{( - \frac{{( x - μ )}^{2}}{2 {σ}^{2}} )} \qquad ( 2 )$$

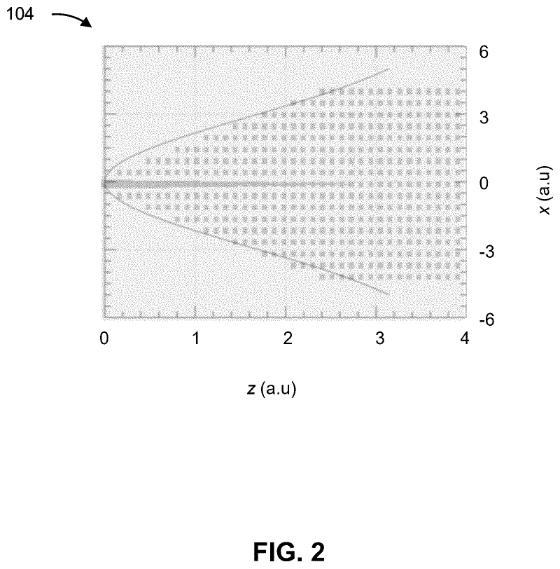

A Gaussian distribution according to Equation 2 is shown in FIG. 2. In some implementations, as illustrated in FIG. 2, the grating elements of the 2D bi-anisotropic SWG structure 104 may be arranged in the Gaussian distribution along the x-direction to approximately an end of the tapered waveguide 102 based on Equation 2, and may continue thereafter with a fixed overall width of 2×R_{swg}. Alternatively, the arrangement of the grating elements of the 2D bi-anisotropic SWG structure 104 may be linear, apodized, parabolic, or the like. In some implementations, the distribution of the grating elements of the 2D bi-anisotropic SWG structure 104 may be designed so as to satisfy a performance requirement for a given application. In some implementations, the effective radius of the grating elements of the 2D bi-anisotropic SWG structure 104 (e.g., R_{swg}, as depicted in FIGS. 1A-1B) may be designed so as to match a mode profile of a specific mode field diameter (MFD) (e.g., 10 μm MFD or any other specified MFD). In the examples provided below, an MFD of the SSC 100 is to be matched with that of an SMF-28 fiber 10 μm MFD.

As indicated above, FIG. 2 is provided as an example. Other examples may differ from what is described with regard to FIG. 2.

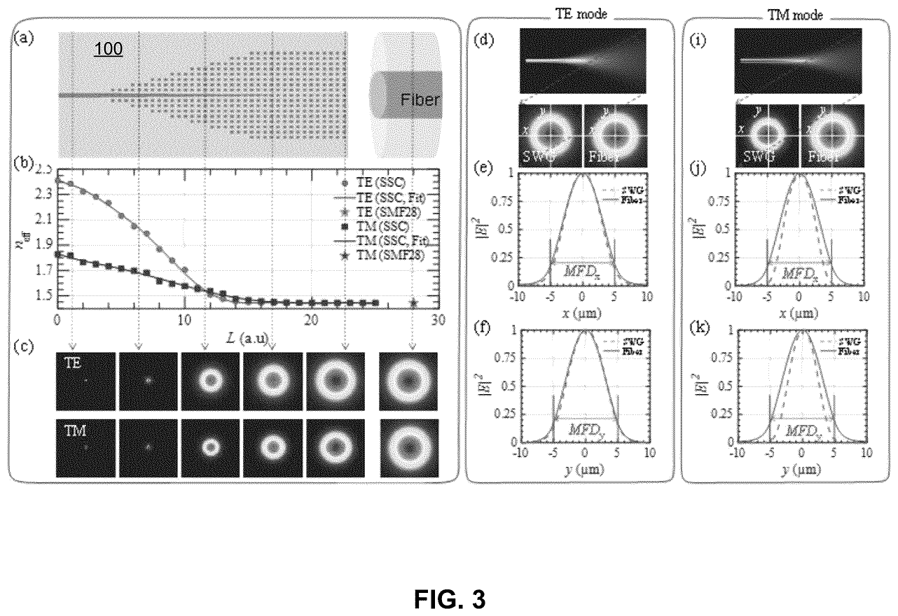

FIGS. 3-6 are diagrams illustrating simulation results associated with various example implementations of the SSC 100 described herein. In the example shown in FIG. 3, the tapered waveguide 102 and the grating elements of the 2D bi-anisotropic SWG structure 104 comprise Si and the cladding 106 comprises silica. In this example, the height h_{tw} of the tapered waveguide 102 is 220 nm and the height h_{swg} of the grating elements is 90 nm (i.e., h_{tw}>h_{swg}). Further, the periodicity Λₓ is 2000 nm, the filling fraction ρₓ is a function of the periodicity Λₓ, the periodicity Λ_{z} is 200 nm, and the filling fraction ρ_{z} is 0.10.

FIG. 3(a) is a plan view of the SSC 100 alongside a SMF-28 fiber. FIG. 3(b) illustrates effective refractive indices (n_{eff}) along a propagation length L. The gray dots and black squares indicate the simulated n_{eff} for the TE mode and the TM mode, respectively, while the solid lines show the corresponding fitted n_{eff}. Notably, the last two data points, shown with stars (overlapping in FIG. 3(b)), present the n_{eff} of the SMF-28 fiber inherent modes. In this example, the TE mode n_{eff} and the TM mode n_{eff} transition smoothly to the SMF-28 mode indices. Corresponding field profiles along the propagation length L are shown in FIG. 3(c). An upper portion of FIG. 3(c) shows the TE mode profiles and how the mode smoothly transitions to that of an SMF-28, while the lower portion of FIG. 3(c) shows the transition for TM mode profiles. Here, the mode diameter increases along the propagation length L. Notably, the TE mode profile closely matches with the SMF-28 fiber (as compared to TM mode). This is due to the asymmetry with respect to the waveguide height and width.

To further analyze the MFD along the x-direction (e.g., horizontal) and the y-direction (e.g., vertical), a 3-dimensional (3D) finite-difference-time-domain (FDTD) analysis can be performed and field profiles can be examined. The results shown in FIGS. 3(d)-(f) are associated with the TE mode and the results in FIGS. 3(i)-(k) are associated with the TM mode. In FIGS. 3(d) and 3(i), the top diagram shows the field profile (e.g., with respect to an x-z plane) along the SSC 100, and the bottom portions show the mode field distributions of the SSC 100 and the SMF-28 fiber—FIG. 3(d) for the TE mode and FIG. 3(i) for the TM mode. FIGS. 3(e) and 3(f) show the MFD of the field intensity for the TE mode. The TE MFDₓ of SSC (dashed lines) and the SMF-28 fiber (solid lines) are shown in FIG. 3(e), and MFDₓ is shown in FIG. 3(f). Similarly, FIGS. 3(j) and 3(k) show the MFD of the field intensity for the TM mode with MFDₓ in FIG. 3(j), and MFD_{y} in FIG. 3(k). As shown, the TE modes MFDₓ and MFD_{y} closely match the SMF-28 fiber inherent TE mode's MFD in this example—10 μm. However, there is some amount of mismatch between the TM modes MFDₓ and MFD_{y} and the SMF-28 inherent TM mode. This mismatch is attributed to the waveguide geometry, which complicates increasing the MFD along the vertical direction. This indicates less insertion loss for the TE mode as compared to the TM mode.

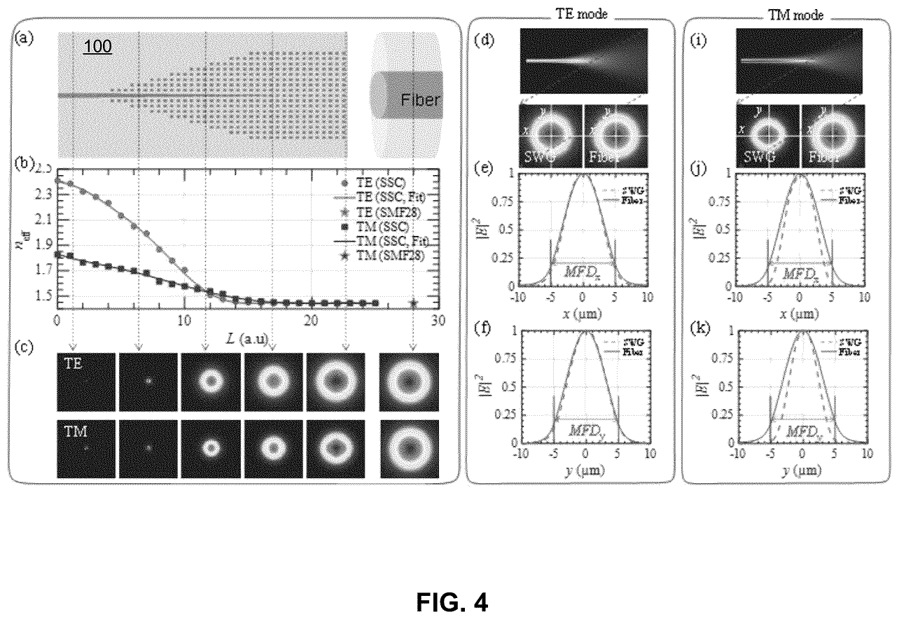

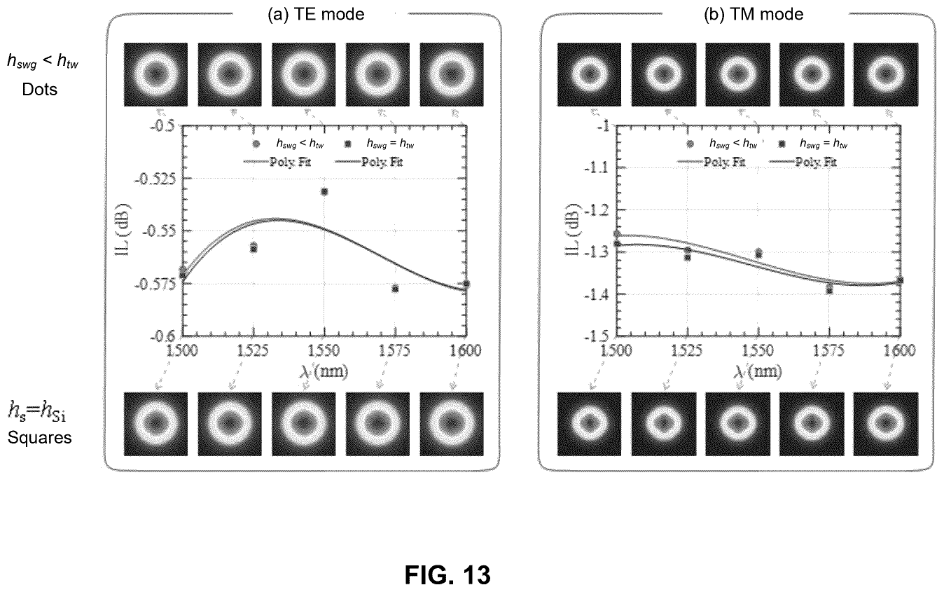

In the example shown in FIG. 4, the tapered waveguide 102 and the grating elements of the 2D bi-anisotropic SWG structure 104 comprise Si and the cladding 106 comprises silica. In this example, the height h_{tw} of the tapered waveguide 102 is 220 nm and the height h_{swg} of the grating elements is 220 nm (i.e., h_{tw}=h_{swg}). Further, the periodicity Λₓ is 2000 nm, the filling fraction ρₓ is a function of the periodicity Λₓ, the periodicity Λ_{z} is 200 nm, and the filling fraction ρ_{z} is 0.10. FIG. 4(a) is a plan view of the SSC 100 alongside a SMF-28 fiber. As shown in FIG. 4(b), the effective indices n_{eff} exhibit a smooth transition along the propagation length L. Here, while there is only a slight variation in n_{eff} (e.g., as compared to that shown in FIG. 3(b)), a slight difference is apparent when examining the field profiles in FIG. 3(c)—with the MFDs shown in the field profiles of FIG. 3(c) being slightly larger than those shown in FIG. 4(c). This is especially true with respect to the TM mode field profiles. Of note, however, the TM mode loss in the example implementation associated with FIG. 4 is increased (e.g., due to scattering from the grating elements), as illustrated in FIG. 13 described below, which illustrates loss variations between the example implementations associated with FIGS. 3 and 4. Conversely, the TE mode has a reduced loss (e.g., caused by variations in the height h_{swg}), which can also be seen in FIG. 13 described below

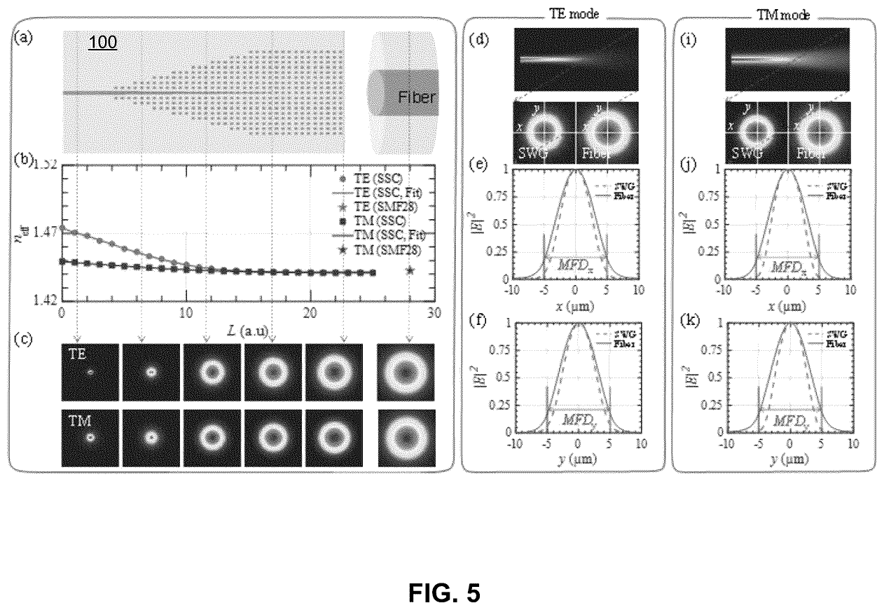

In the example shown in FIG. 5, the tapered waveguide 102 and the grating elements of the 2D bi-anisotropic SWG structure 104 comprise SiNₓ and the cladding 106 comprises silica. In this example, the height h_{tw} of the tapered waveguide 102 is 160 nm and the height h_{swg} of the grating elements is 160 nm (i.e., h_{tw}=h_{swg}). Further, the periodicity Λₓ is 2000 nm, the filling fraction ρₓ is a function of the periodicity Λₓ, the periodicity Λ_{z} is 200 nm, and the filling fraction ρ_{z} is 0.10. FIG. 5(a) is a plan view of the SSC 100 alongside a SMF-28 fiber. FIG. 5(b) shows the effective refractive indices n_{eff} along the propagation length L for the TE mode (dots) and the TM mode (squares). The star-shaped data points (overlapping in FIG. 5(b)) show the SMF-28 fiber inherent TE and TM modes. The lines represent the fitted n_{eff} for the TE and TM modes. The n_{eff} plot illustrates that the TE and TM modes gradually transition to the n_{eff} of the SMF-28 fiber inherent modes. FIG. 5(c) shows the corresponding mode profiles—the top for TE modes and the bottom for TM modes, and illustrates how the initial mode diameter adjusts to approach the mode diameter of the SMF-28 fiber. Notably, there is a match between the TE and TM mode profiles and the SMF-28.

Here again, a 3D FDTD analysis can be performed and field profiles can be examined in order to evaluate the matching of the modes with those of the SMF-28 fiber modes. FIGS. 5(d) and (i) illustrate surface field profiles (e.g., with respect to an x-z plane) alongside cross-sectional x-y views of the mode profiles for both the SSC 100 and the SMF-28 fiber modes—FIG. 5(d) for TE modes and FIG. 5(i) for TM modes. One-dimensional intensity profiles with respect to the x-axis and the y-axis are shown in FIGS. 5(e) and (f) for TE modes and in FIGS. 5(j) and (k) for TM modes. Notably, the TE and TM modes MFDₓ (i.e., along the x-direction) and MFD_{y} (i.e., along the y-direction) match with those of the SMF-28 fiber inherent TE and TM modes. However, there is some amount of mismatch in MFD, indicating a potential slightly higher loss in a SiNₓ-based 2D bi-anisotropic SWG structure 104 (e.g., as compared to a Si-based 2D bi-anisotropic SWG structure 104).

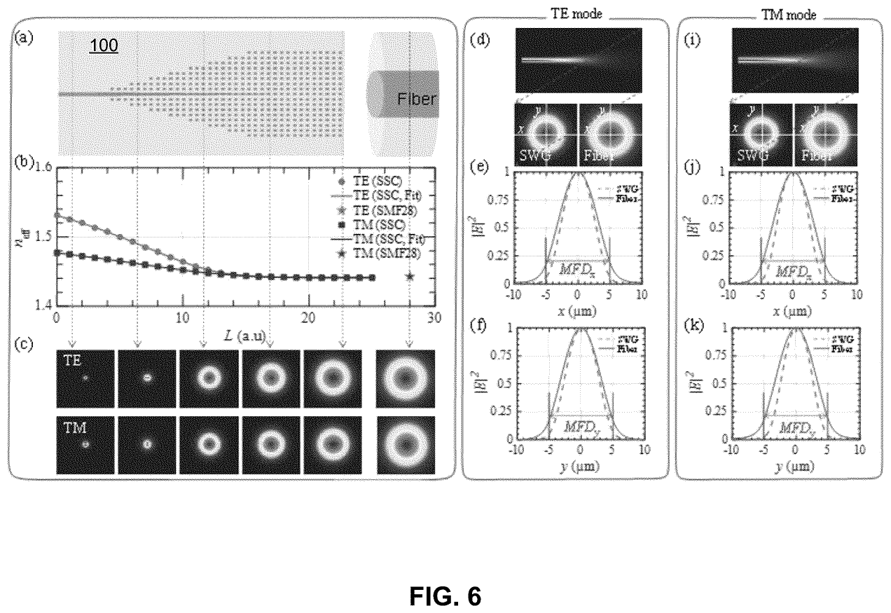

In the example shown in FIG. 6, the tapered waveguide 102 and the grating elements of the 2D bi-anisotropic SWG structure 104 comprise SiNₓ and the cladding 106 comprises silica. In this example, the height h_{tw} of the tapered waveguide 102 is 250 nm and the height h_{swg} of the grating elements is 250 nm (i.e., h_{tw}=h_{swg}). Here, the heights h_{tw} and h_{swg} are greater than those in the example associated with FIG. 5. Further, the periodicity Λₓ is 2000 nm, the filling fraction ρₓ is a function of the periodicity Λₓ, the periodicity Λ_{z} is 200 nm, and the filling fraction ρ_{z} is 0.10. FIG. 6(a) is a plan view of the SSC 100 alongside a SMF-28 fiber. Comparing the performance as illustrated by FIG. 5 and FIG. 6, there is no significant difference when the height h_{tw} and the height h_{swg} are greater than approximately 150 nm. This indicates that the design of the SiNₓ-based SSC 100 can accommodate various heights, adapting to the differing SiNₓ height standards (e.g., of various foundries or processes).

Therefore, as indicated by the above examples, the designs of both Si-based SSCs 100 and SiNₓ-based SSCs 100 are highly robust and are capable of being implemented across different material platforms and foundries without significant impact on performance.

As indicated above, FIGS. 3-6 are provided as examples. Other examples may differ from what is described with regard to FIGS. 3-6.

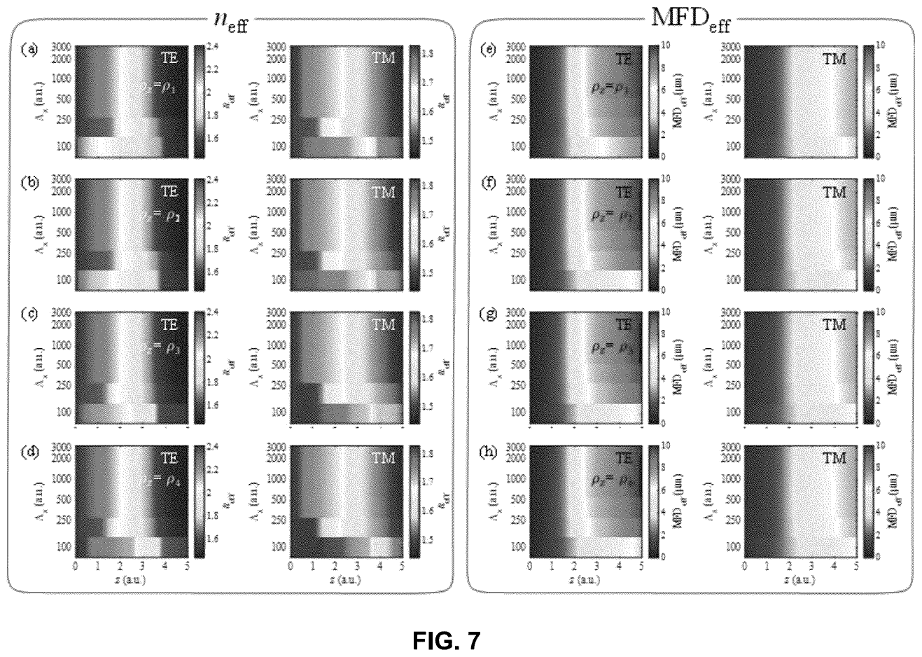

FIGS. 7-12 are diagrams illustrating simulation results illustrating effects of different parametric variations associated with the SSC 100 described herein. FIG. 7 illustrates effective indices n_{eff} for various values of the filling fraction ρ_{z} along the direction of propagation (e.g., the z-direction) for an Si-based SSC 100 (e.g., an SSC 100 in which the tapered waveguide 102 and the grating elements of the 2D bi-anisotropic SWG structure 104 comprise Si), with TE mode results on the left and TM mode on the right. In the examples shown in FIGS. 7(a)-(d), the periodicity Λₓ changes from 100 nm 3000 nm, which influences the filling fraction ρₓ (e.g., ρₓ=f(Λₓ)). In FIGS. 7(a)-(d), different filling fractions are used: ρ_{z}=0.10 in (a), ρ_{z}=0.25 in (b), ρ_{z}=0.50 in (c), and ρ_{z}=0.75 in (d) while keeping Λ_{z}=200 nm. Further, the 2D bi-anisotropic SWG structure 104 has a radius R_{swg}=7 μm, the height h_{tw}=220 nm, and the height h_{swg}=90 nm. As shown, the change in ρ_{z} does not lead to significant differences in effective indices with larger periodicity Λₓ. However, at a lower periodicity Λₓ (e.g., approximately 100 nm to approximately 200 nm), using a smaller ρ_{z} (e.g., 0.10) results in fast transition in the effective indices along the propagation length L as compared to a larger ρ_{z} values (e.g., 0.75). Thus, a smaller ρ_{z} may contribute to increased loss. However, the 2D bi-anisotropic SWG structure 104 can be designed with a larger periodicity Λₓ (e.g., Λₓ>1000 nm), meaning that these discrepancies from ρ_{z} become negligible, which indicates a minimal impact on performance.

A 3D FDTD was performed for each case of FIGS. 7(a)-(d) and effective mode field diameters (MFD_{eff}) were calculated as follows:

$${A}_{eff} = \frac{{[ \int \int {\vert E ( x , y ) \vert}^{2} dxdy ]}^{2}}{\int \int {\vert E ( x , y ) \vert}^{4} dxdy} \qquad ( 3 )$$

$${MFD}_{eff} = 2 \sqrt{\frac{{A}_{eff}}{π}} \qquad ( 4 )$$

where E(x, y) represents the mode electric field profile on an x-y plane, and A_{eff} refers to the effective mode area. The MFD_{eff} can be calculated using Equations 3 and 4, and the corresponding maps are shown in FIGS. 7(e)-(h). Notably, the MFD_{eff} for the TE mode, when the periodicity Λₓ is greater than 1000 nm, matches closely with that of the SMF-28 fiber, achieving an MFD_{eff} of 10 μm across various filling fractions ρ_{z}, as shown in FIGS. 7(e)-(h). In contrast, for the TM mode under similar conditions (i.e., periodicity Λₓ>100 nm), the MFD_{eff} ranges from approximately 7 μm to approximately 8 μm (FIGS. 7(e)-(h)), meaning that the TM mode has more coupling/insertion loss as compared to TE mode. Moreover, at a smaller periodicity Λₓ (e.g., approximately 100 nm to approximately 200 nm), the mode field diameter spans from approximately 6 μm to approximately 8 μm for the TE mode, and from approximately 6 μm to approximately 7 μm for the TM mode. This indicates increased losses for both the TE and TM modes at these smaller periodicity Λₓ, which is due to the scattering from the grating elements. However, for larger periodicity Λₓ (e.g., Λₓ>1000 nm), both polarization modes operate effectively with minimal insertion losses when coupled to SMF-28. Thus, the SSC 100 is robust with respect to variations of the filling fraction ρ_{z}.

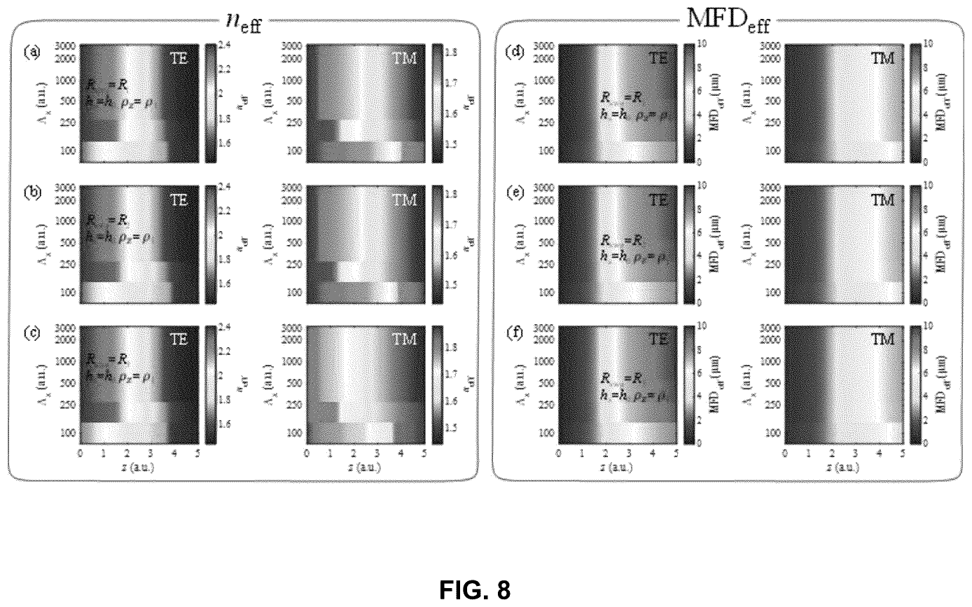

FIGS. 8(a)-(c) illustrate simulation results associated with evaluating the effective indices n_{eff} for various values of the radius R_{swg} for an Si-based SSC 100, with TE mode results on the left and TM mode on the right. In this example, the periodicity Λₓ is varied from 100 nm to 3000 nm with the filling fraction ρₓ being a function of the periodicity Λₓ (e.g., ρₓ=f(Λₓ)). The radii R_{swg} used in this example are shown in FIGS. 8(a)-(c) as follows: (a) R_{swg}=5 μm, (b) R_{swg}=7 μm, and (c) R_{swg}=9 μm. The filling fraction ρ_{z} is 0.10, the periodicity Λ_{z} is 200 nm, and the height h_{swg} is 90 nm. The map plots show minimal changes in the effective indices n_{eff} within this range of radii R_{swg}. However, at periodicity Λₓ from 100 nm to 200 nm, there is a fast transition in the effective indices n_{eff} along the direction of propagation (e.g., as compared to larger values of the periodicity Λₓ). This means that the SSC 100, with smaller values of the periodicity Λₓ, will experience higher loss. Conversely, for a larger periodicity Λₓ (e.g., Λₓ>1000 nm) there is a smooth modal transition of TE and TM modes indices to the SMF-28 mode indices, which suggests minimal loss.

FIGS. 8(d)-(f) show results of 3D FDTD simulations being performed and MFD_{eff} being calculated (using Equations 3 and 4) for each scenario given in FIGS. 8(a)-(c), with the TE mode shown on the left and the TM mode on the right. For the various waveguide radii (R_{swg}=5 μm, 7 μm, and 9 μm) and with periodicity Λₓ greater than 250 nm, the TE mode MFD_{eff} closely aligns with the 10 μm MFD of the SMF-28 fiber. In contrast, the TM mode shows an MFD_{eff} of approximately 8 μm, indicating a higher insertion loss as compared to the TE mode. Both the TE and TM modes experience greater mode mismatch, which increases insertion losses at smaller values of periodicity Λₓ, as shown in FIGS. 8(d)-(f). However, with larger values of the periodicity Λₓ, variations in the radius R_{swg} are within the given range and do not affect performance of the SSC. Thus, a Si-based SSC 100 is robust to variations of the radius R_{swg}. Of note, with respect to these examples, the radius R_{swg} may need to be engineered so as to expand the mode field diameter to approximately 10 μm.

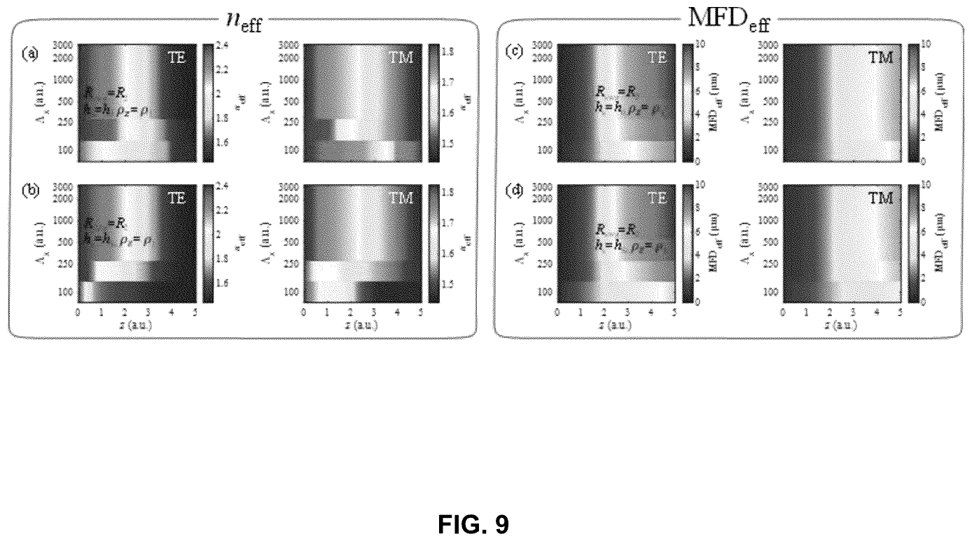

FIGS. 9(a)-(b) present the effective indices n_{eff} maps for various values of the height h_{swg} and periodicity Λₓ: (a) for a height h_{swg} of 90 nm, and (b) for a height h_{swg} of 220 nm. Here, the height h_{tw} is 220 nm, the periodicity Λ_{z} is 200 nm, the filling fraction ρ_{z} is 0.10, and the radius R_{swg} is 7 μm. Further, the periodicity Λₓ is in units of nm and the filling fraction ρₓ is adjusted as described above with respect to FIGS. 7 and 8. As shown, for a larger height h_{swg}, there is a fast change in the effective index n_{eff} (e.g., shown in FIG. 9(b)), which may contribute to radiation losses. Conversely, at a larger periodicity Λₓ (e.g., Λₓ>1000 nm), the modal transition of the effective index n_{eff} is smoother, similar to as observed with respect to FIGS. 7 and 8. For both the height h_{swg} of 90 nm and the height h_{swg} of 220 nm, the effective MFD_{eff} (calculated using Equations 3 and 4 based on 3D FDTD simulations) are given in FIGS. 9(c) and (d) for the cases shown in FIGS. 9(a) and (b), respectively. These figures replicate findings illustrated with respect to FIGS. 7 and 8 with a larger periodicity Λₓ. Notably, variations in the height h_{swg} have minimal impact on the MFD_{eff}, which indicates significant tolerance to height variation of the grating elements of the 2D bi-anisotropic SWG structure 104 during fabrication.

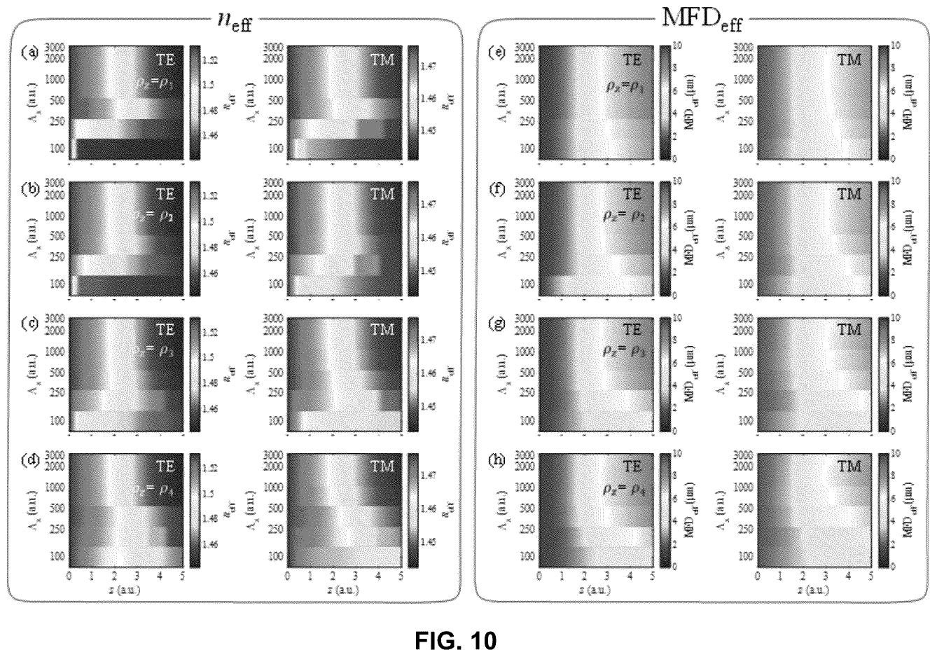

The effect of geometric variations on the effective indices n_{eff} for an SiNₓ-based SSC 100 (e.g., an SSC 100 in which the tapered waveguide 102 and the grating elements of the 2D bi-anisotropic SWG structure 104 comprise SiNₓ) can be similarly evaluated. FIGS. 10 (a)-(d) show the effective indices n_{eff} maps for various filling fractions ρ_{z}, with configurations (a) ρ_{z}=0.10, (b) ρ_{z}=0.25, (c) ρ_{z}=0.50, and (d) ρ_{z}=0.75. Here, the radius R_{swg} is 7 μm, the height h_{swg} is 250 nm, and the height h_{tw} is 250 nm. As shown, a smaller periodicity Λₓ leads to a fast transition in the effective index n_{eff}, which increases radiation losses. Moreover, the effective index n_{eff} is not close to silica index/SMF-28 mode indices when ρ_{z} 0.75 and the periodicity Λₓ is less than 250 nm, which impacts tightness of field confinement within the grating elements of the 2D bi-anisotropic SWG structure 104. However, when the periodicity Λₓ is greater than 1000 nm, a smoother transition in the effective index n_{eff} across varying periodicity ρ_{z} is present, which indicates a minimal impact on performance and a large fabrication tolerance.

To verify the mode diameter, 3D FDTD simulations for each configuration as given in FIGS. 10 (a)-(d) were performed, and Equations 3 and 4 were used to calculate the corresponding MFD_{eff}, results of which are shown in FIGS. 10(e)-(h). Here, for a larger periodicity Λₓ, the MFD_{eff} for the TE mode is greater than approximately 9 μm, while for the TM mode, the MFD_{eff} ranges from approximately 7 μm to approximately 8 μm, which indicates higher insertion losses for the TM mode. Conversely, at a lower periodicity Λₓ, both polarizations show an MFD_{eff} of approximately 6 μm, which can lead to significant mode mismatch and increased insertion losses. Therefore, the periodicity Λₓ may in some implementations be selected at a sufficiently high value to ensure that the MFD_{eff} for both modes matches that of SMF-28, demonstrating a high tolerance to variations in SiNₓ grating element widths (i.e., Λ_{z}ρ_{z}) along the direction of propagation.

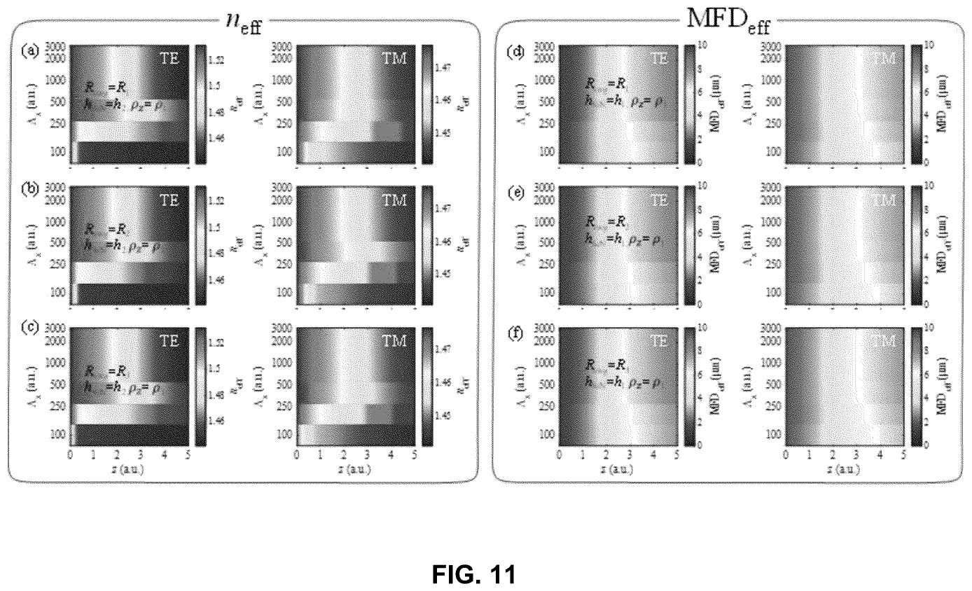

FIGS. 11(a)-(c) illustrate simulation results of the effective index n_{eff} for varying values of the radius R_{swg} for a SiNₓ-based SSC 100, with the TE mode being shown on the left and the TM mode being shown on the right. With the radius R_{swg}, the periodicity Λₓ and the filling fraction ρₓ are varied. The radius R_{swg} used in the simulations are shown in FIG. 11(a)-(c) as follows: (a) R_{swg}=5 μm, (b) R_{swg}=7 μm, and (c) R_{swg}=9 μm. Further, the periodicity ρ_{z} is 0.10, the periodicity Λ_{z} is 200 nm, the height h_{tw} is 250, and the height h_{swg} is 250 nm. As shown in FIGS. 11(a)-(c), there is no significant difference in the effective index n_{eff} while varying the radius R_{swg} with a large periodicity Λₓ (e.g., Λₓ>1000 nm). However, for a smaller periodicity Λₓ (irrespective of the filling fraction ρ_{z}), the effective index n_{eff} changes fast, adding to the radiation losses.

FIGS. 11 (d)-(f) show results of 3D FDTD simulations and MFD_{eff} calculation (using Eqs. 3 and 4) for each case given in FIGS. 11(a)-(c). For the various values of the radius R_{swg} and with a larger periodicity Λₓ (e.g., Λₓ>1000 nm), the TE mode MFD_{eff} is approximately 9 μm. In contrast, the TM mode shows an MFD_{eff} from approximately 7 μm to approximately 8 μm, indicating a higher insertion loss as compared to the TE mode. Both the TE and TM modes experience greater mode mismatch, causing large insertion losses at smaller values of the periodicity Λₓ, as shown in FIGS. 11(d)-(f). However, with a larger periodicity Λₓ, variations in the radius R_{swg} are acceptable within the given range. Notably, the radius R_{swg} may need to be designed so as to correspond to the MFD of the SMF-28. In this example, the MFD is 10 μm, and so different radii R_{swg} are chosen so as to optimize the effective radius. As given in FIG. 11, there are no obvious performance challenges, meaning that a SiNₓ-based SSC 100 is robust to variations in the radius R_{swg}.

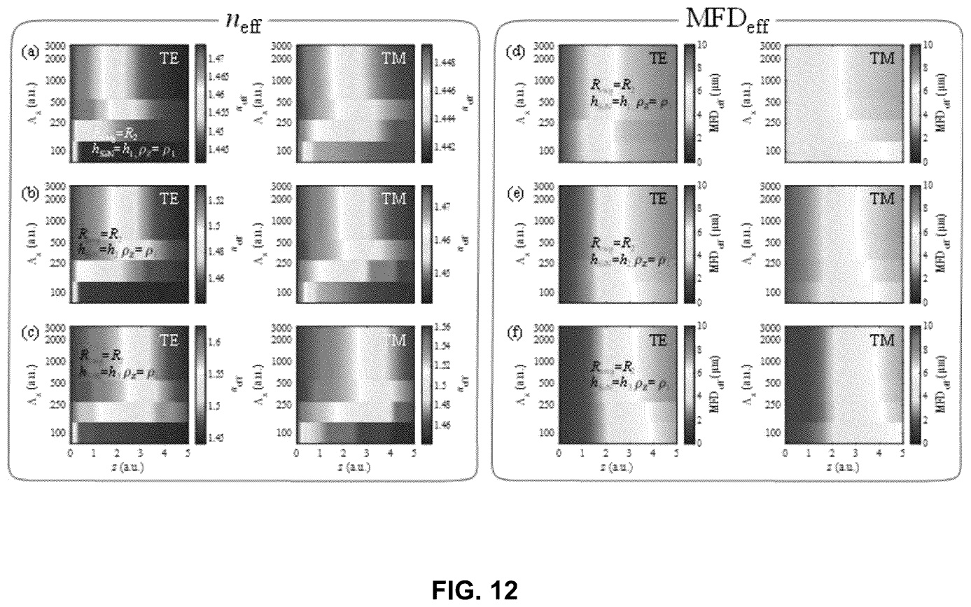

FIGS. 12(a)-(c) illustrate map plots of the effective index n_{eff} resulting from simulations of an SiNₓ-based SSC 100 with varying values of the height h_{swg}: (a) h_{swg}=160 nm, (b) h_{swg}=250 nm, and (c) h_{swg}=400 nm. In this example, the height h_{tw} matches the height h_{swg}. Further, the filling fraction ρ_{z} is 0.10, the periodicity Λ_{z} is 200 nm, and the radius R_{swg} is 7 μm. As shown in FIG. 12(a), for a smaller height h_{swg} and a larger periodicity Λₓ, there is smooth modal transition of SiNₓ waveguide modes to SMF-28 fiber modes. With a smaller periodicity Λₓ, as shown in FIGS. 12(a)-(c), a fast effective index n_{eff} transition from waveguide mode to the SWG mode might cause radiation loss. With a larger periodicity Λₓ (e.g., Λₓ>1000 nm), there is a smooth effective index n_{eff} change from SiNₓ to SMF-28. Notably, within the height h_{swg} variations, there is no significant change in the effective index n_{eff} if the periodicity Λₓ is relatively large, meaning that the design is tolerant to variations in the height h_{swg} such cases.

FIGS. 12(d)-(f) illustrate MFD_{eff} calculated based on a 3D FDTD simulation for the different values of the height h_{swg}. Similar to the examples shown in FIGS. 10 and 11, the TE MFD_{eff} is approximately 9 μm and the TM MFD_{eff} is approximately 7-8 μm. Thus, the TM mode may have more insertion loss than the TE mode. With a large periodicity Λₓ, the same observations as shown in FIGS. 10 and 11 are seen in this example. Thus, variations in the height h_{swg} have minimal impact on MFD_{eff}, which indicates a large tolerance to variation in the height h_{swg} during fabrication.

As indicated above, FIGS. 7-12 are provided as examples for illustrative purposes. More specifically, the parameter values of the SSCs 100 associated with FIGS. 7-12 are provided for the purpose of illustration, and an SSC 100 (e.g., an Si-based SSC 100, a SiNₓ-based SSC 100, or an Si/SiNₓ-based SSC 100) may be designed with parameter values that differ from those used in the examples associated with FIGS. 7-12.

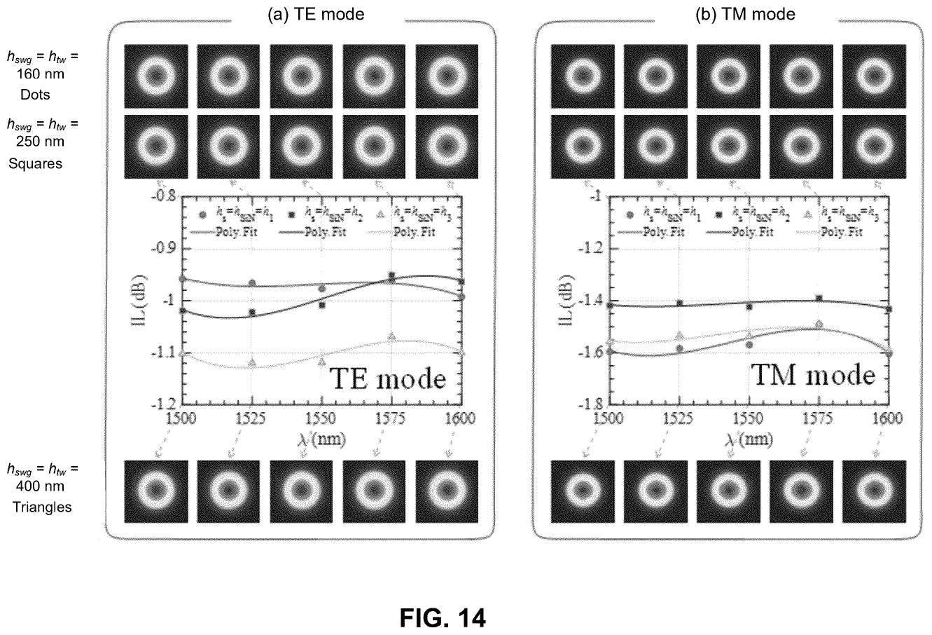

FIGS. 13-14 are diagrams illustrating simulation results illustrating insertion loss and PDL associated with the SSC 100 described herein. FIG. 13 illustrates such simulation results for an Si-based SSC 100. 3D FDTD simulations on the Si-based SSC 100 with an SMF-28 fiber for both TE and TM modes were performed to analyze wavelength-dependent losses, insertion losses, and polarization dependent losses of an Si-based SSC 100 with a structure as shown in FIGS. 1A and 1B. The TE and TM modes were launched as inputs to the SSC 100, and field coupling to the SMF-28 fiber was monitored. The simulated results are shown in FIG. 13, with (a) showing the TE mode and (b) showing the TM mode. Here, there are two scenarios: height h_{swg}=90 nm and height h_{tw}=220 nm (i.e., h_{swg}<h_{tw}, as shown in FIG. 1A), and height h_{swg}=220 nm and height h_{tw}=220 nm (i.e., height h_{swg}=height h_{tw}, as shown in FIG. 1B). Here, the periodicity Λ_{z} is 200 nm, the filling fraction ρ_{z} is 0.10, the periodicity Λₓ is 2000 nm, the filling fraction ρₓ is a function of the periodicity Λₓ (e.g., ρₓ=f(Λₓ), and the radius R_{swg} is 7 μm. FIGS. 13(a)-(b) show the mode field profiles of TE and TM modes, respectively, as they propagate into a SMF-28 fiber at different wavelengths λ for the h_{swg}<h_{tw} scenario (top plots) and the h_{swg}=h_{tw} scenario (bottom plots). The dashed arrows, as shown in FIGS. 13(a)-(b), indicate minimal variation in the field profiles from approximately 1500 nm to approximately 1600 nm, which indicates low wavelength dependent loss and low and flat insertion loss spectra. The analyses described above with respect to FIGS. 3 and 4 show a close match of MFD between the SSC 100 and SMF-28 fiber modes. Further, the TE mode has a close match as compared to the TM mode. The parametric analysis as described above with respect to FIGS. 7-9 confirms these observations.

To assess the insertion losses, the propagated modes in the SMF-28 fiber were overlapped against the SMF-28 fiber inherent modes. A 3D FDTD further confirms a low insertion loss for the TE mode, as illustrated in the middle plot of FIG. 13(a), and a slightly higher loss for the TM mode, as illustrated in the middle plot of FIG. 13(b). The dots and squares show the simulation data for the h_{swg}<h_{tw} scenario and the h_{swg}=h_{tw} scenario, respectively, with polynomial fits shown as solid lines. Notably, there is no significant difference in insertion loss spectra between the two scenarios for the TE and TM modes. Over a range of wavelength λ from 1500 nm to 1600 nm, the insertion loss for the TE mode is less than approximately 0.6 dB, and the wavelength dependent loss is less than approximately 0.03 dB. For the TM mode, the insertion loss is less than approximately 1.3 dB, and the wavelength dependent loss is less than approximately 0.11 dB. The polarization dependent loss is less than approximately 0.75 dB at 1550 nm. Given these results, the Si-based SSC 100 is suitable for a 100 nm broad C-band (e.g., 1530 nm to 1565 nm) application, and geometric properties of the tapered waveguide 102 and/or the 2D bi-anisotropic SWG structure 104 may be adjusted for use in other bands, such as the O-band or the L-band (e.g., 1565 nm to 1625 nm). Further, the SSC 100 is tolerant to process variations and has low nonlinearity (e.g., as compared to traditional Si SSC design), meaning that the SSC 100 including the 2D bi-anisotropic SWG structure 104 is suitable for high-power applications.

FIG. 14 illustrates such simulation results for an SiNₓ-based SSC 100. 3D FDTD simulations on the SiNₓ-based SSC 100 with an SMF-28 fiber for both TE and TM modes were performed to analyze wavelength-dependent losses, insertion losses, and polarization dependent losses of an Si-based SSC 100 with a structure as shown in FIG. 1B. A 3D FDTD analysis was performed on the geometry with an SMF-28 fiber. The TE and TM modes were excited as inputs to the SiNₓ-based SSC 100 and field coupling to the fiber was monitored. Simulation results are given in FIG. 14, where (a) shows the TE mode and (b) shows the TM mode. Three scenarios were analyzed: height h_{swg}=height h_{tw}=160 nm, h_{swg}=height h_{tw}=250 nm, and h_{swg}=height h_{tw}=400 nm. Here, the periodicity Λ_{z} is 200 nm, the filling fraction ρ_{z} is 0.10, the periodicity Λₓ is 2000 nm, the filling fraction ρₓ is a function of the periodicity Λₓ (e.g., ρₓ=f(Λₓ), and the radius R_{swg} is 7 μm. In FIGS. 14(a)-(b), the top (first and second) and bottom plots show the mode shapes of the launched TE and TM modes into a SMF-28 fiber.

Here, the first scenario (i.e., height h_{swg}=height h_{tw}=160 nm) is shown at the first top, the second scenario (i.e., height h_{swg}=height h_{tw}=250 nm) is shown at the second top, and the third scenario (i.e., height h_{swg}=height h_{tw}=400 nm) is shown at the bottom. The field profiles in the range of wavelength from 1500 nm to 1600 nm show minimal variation, indicated by dashed arrows, which indicates low wavelength dependent loss, low insertion loss, and a relatively flat spectral response. To assess the insertion losses, the propagated modes from the SiNₓ-based SSC 100 were overlapped with the SMF-28 fiber's inherent modes. As illustrated in FIG. 5 described above, there is a match between the MFD of the TE and TM modes of the SiNₓ-based SSC 100 and the SMF-28 fiber. The parametric analysis, as described above with respect to FIG. 12, shows minimal variation as the height h_{swg} changes. The 3D FDTD simulations support these observations, indicating a low insertion loss for the TE mode, as shown in the middle plot of FIG. 14(a), and a slightly higher loss for the TM mode, as shown in the middle plot of FIG. 14(b). The dots, squares, and triangles in FIG. 14 show the simulation data for the first scenario, the second scenario, and the third scenario, respectively, with polynomial fits shown as solid lines. Of note, the first scenario (i.e., h_{swg}=height h_{tw}=160 nm) has a lower insertion loss for the TE moder and a higher IL for the TM mode, and the third scenario (i.e., h_{swg}=height h_{tw}=400) illustrates the opposite result. This is due to the asymmetry in waveguide height and width. Thus, dimensions similar to those in the second scenario (i.e., h_{swg}=height h_{tw}=250) may in some cases be chosen so as to improve insertion loss both for the TE and TM modes. For the second scenario, over the range of wavelength from 1500 nm to 1600 nm, the insertion loss, as shown in FIG. 14(a) for the TE mode, is approximately 1.0 dB, and the wavelength dependent loss is less than approximately 0.08 dB. With respect to the TM mode for the second scenario, as shown in FIG. 14(b), insertion loss is approximately 1.4 dB, and wavelength dependent loss is less than approximately 0.05 dB. Further, the polarization dependent loss is less than approximately 0.4 dB at 1550 nm. Therefore, SiNₓ-based SSC 100 may be suitable for a 100 nm broad C-band application. Of course, geometric properties of the tapered waveguide 102 and/or the 2D bi-anisotropic SWG structure 104 of the SiNₓ-based SSC 100 can be selected for operation in another band, such as the O-band or the L-band. Of further note, the SiNₓ-based SSC 100 is tolerant to process variations and has reduced nonlinearity, which makes the SiNₓ-based SSC 100 useful for high-power applications.

As indicated above, FIGS. 13-14 are provided as examples for illustrative purposes. More specifically, the parameter values of the SSCs 100 associated with FIGS. 13-14 are provided for the purpose of illustration, and an SSC 100 (e.g., an Si-based SSC 100, a SiNₓ-based SSC 100, or an Si/SiNₓ-based SSC 100) may be designed with parameter values that differ from those used in the examples associated with FIGS. 13-14.

In this way, an SSC 100 including a 2D bi-anisotropic SWG structure 104 may provide one or more of the following features and advantages: (1) an SSC capable of manipulating beam mode field diameter or profiles; (2) vertical and horizontal mode field diameter that is controlled using specific geometric parameters (e.g., a periodicity Λₓ, a periodicity Λ_{z}, a filling fraction ρₓ, a filling fraction ρ_{z}, a radius R_{swg}, or the like); (3) a smaller mode transition length or taper length as compared to a conventional SSC; (4) coupling with an arbitrary mode field diameter SMF (e.g., a fiber with a 6 μm MFD, an 8 μm MFD, a 10 μm MFD, or the like); (5) lower nonlinearity as compared to a conventional waveguide, which reduces nonlinear losses and is of particular benefit for a high-power application; (6) improved tolerance to variations in parameters (e.g., tip width), fabrication processes, and other procedural changes, as compared to a conventional waveguide; (7) adaptability for use across different wavelength ranges (e.g., very-near infrared, such as approximately 780 nm to approximately 1300 nm, as well as the O-band, the E-band, the S-band, the C-band, or the L-band), with only adjustments to waveguide parameters; or (8) compatibility with other material platforms (with appropriate adjustment of waveguide dimensions).

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When a component or one or more components (e.g., a waveguide or one or more laser waveguide) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. A photonic integrated circuit (PIC) comprising a spot size converter (SSC), the SSC comprising:
a tapered waveguide having a length along a first direction and a width along a second direction,
wherein the first direction is parallel to a direction of propagation and the second direction is perpendicular to the direction of propagation; and
a two-dimensional (2D) bi-anisotropic subwavelength grating (SWG) structure, wherein a portion of the 2D bi-anisotropic SWG structure surrounds a portion of the tapered waveguide in the second direction and along the first direction.

2. The PIC of claim 1, wherein a periodicity of grating elements of the 2D bi-anisotropic SWG structure along the first direction is different from a periodicity of the grating elements of the 2D bi-anisotropic SWG structure along the second direction.

3. The PIC of claim 1, wherein a periodicity of grating elements of the 2D bi-anisotropic SWG structure along the first direction matches a periodicity of the grating elements of the 2D bi-anisotropic SWG structure along the second direction.

4. The PIC of claim 1, wherein a filling fraction of the grating elements of the 2D bi-anisotropic SWG structure along the first direction is different from a filling fraction of the grating elements of the 2D bi-anisotropic SWG structure along the second direction.

5. The PIC of claim 1, wherein a filling fraction of the grating elements of the 2D bi-anisotropic SWG structure along the first direction matches a filling fraction of the grating elements of the 2D bi-anisotropic SWG structure along the second direction.

6. The PIC of claim 1, wherein one or more of the grating elements of the 2D bi-anisotropic SWG structure have a rectangular shape, an elliptical shape, or a trapezoidal shape.

7. The PIC of claim 1, wherein a dimension of the grating elements is based on a wavelength range associated with the SSC.

8. The PIC of claim 1, wherein the grating elements of the 2D bi-anisotropic SWG structure are symmetrically distributed along the tapered waveguide and extend along the first direction.

9. The PIC of claim 1, wherein a dielectric constant of the bi-anisotropic SWG structure along the first direction is different from a dielectric constant of the bi-anisotropic SWG structure along the second direction.

10. The PIC of claim 1, wherein a dielectric constant of the bi-anisotropic SWG structure along a third direction is different from the dielectric constant of the bi-anisotropic SWG structure along the first direction and the dielectric constant of the bi-anisotropic SWG structure along the second direction.

11. The PIC of claim 1, wherein a height of the grating elements of the 2D bi-anisotropic SWG structure is different than a height of the tapered waveguide.

12. The PIC of claim 1, wherein a height of the grating elements of the 2D bi-anisotropic SWG structure matches a height of the tapered waveguide.

13. The PIC of claim 1, wherein the tapered waveguide comprises at least one of silicon or silicon nitride.

14. The PIC of claim 1, wherein the tapered waveguide is a segmented waveguide.

15. The PIC of claim 1, wherein the 2D bi-anisotropic SWG structure comprises silicon grating elements surrounded by one or more of silica, an index matching fluid, or air.

16. The PIC of claim 1, wherein the 2D bi-anisotropic SWG structure comprises silicon nitride grating elements surround by one or more of silica, an index matching fluid, or air.

17. The PIC of claim 1, wherein the periodicity of the grating elements of the 2D bi-anisotropic SWG structure along the first direction and the periodicity of the grating elements of the 2D bi-anisotropic SWG structure along the second direction are less than approximately λ/n, where λ is an operational wavelength associated with the SSC and n is a refractive index of the 2D bi-anisotropic SWG structure.

18. The PIC of claim 1, wherein the grating elements of the 2D bi-anisotropic SWG structure are oriented at 90° with respect to the direction of propagation.

19. The PIC of claim 1, wherein the grating elements of the 2D bi-anisotropic SWG structure are oriented at an arbitrary angle with respect to the direction of propagation.

20. The PIC of claim 1, wherein the grating elements of the 2D bi-anisotropic SWG structure are arranged in a Gaussian pattern, a linear pattern, an apodized pattern, or a parabolic pattern with respect to a plane defined by the first direction and the second direction.

21. A photonic integrated circuit (PIC) comprising a spot size converter (SSC), the SSC comprising:
a first section comprising a first portion of a tapered waveguide;
a second section comprising a second portion of the tapered waveguide and a first portion of a bi-anisotropic subwavelength grating (SWG) structure comprising a plurality of grating elements,
wherein the second portion of the bi-anisotropic SWG structure surrounds the second portion of the tapered waveguide along a length of the second section; and
a third section comprising a second portion of the bi-anisotropic SWG structure.

22. A photonic integrated circuit (PIC) comprising a spot size converter (SSC), the SSC comprising:
a waveguide having a length along a first direction and a width along a second direction that is perpendicular to the first direction; and
a two-dimensional (2D) bi-anisotropic subwavelength grating (SWG) structure around a portion of the tapered waveguide along the first direction,
wherein a dielectric constant of the bi-anisotropic SWG structure with respect to the first direction is different from a dielectric constant of the bi-anisotropic SWG structure with respect to the second direction, and
wherein the dielectric constant of the bi-anisotropic SWG structure with respect to a third direction is different from the dielectric constant of the bi-anisotropic SWG structure with respect to the first direction and the dielectric constant of the bi-anisotropic SWG structure with respect to the second direction.
